(19) United States
(12) Patent Application Publication
(10) Pub. No.: US 2025/0172481 A1
(43) Pub. Date: May 29, 2025

(54) HIGH-PRESSURE FLOW-CIRCULATING HYDROGEN PERMEATION TEST DEVICE AND METHOD

(71) Applicant: CHINA UNIVERSITY OF PETROLEUM(EAST CHINA), Qingdao, Shandong (CN)

(72) Inventors: Cuiwei LIU, Qingdao (CN); Cailin WANG, Qingdao (CN); Mengze ZHU, Qingdao (CN); Yuxing LI, Qingdao (CN); Jianlu ZHU, Qingdao (CN); Hui HAN, Qingdao (CN); Mingliang LIU, Qingdao (CN); Huimin ZHANG, Qingdao (CN)

(73) Assignee: CHINA UNIVERSITY OF PETROLEUM(EAST CHINA), Qingdao, Shandong (CN)

(21) Appl. No.: 18/841,048

(22) PCT Filed: Jun. 28, 2023
(86) PCT No.: PCT/CN2023/103037

§ 371 Date: Aug. 23, 2024

(30) Foreign Application Priority Data
Dec. 14, 2022 (CN) 202211606866.8

(51) Int. Cl. G01N 15/08; G01N 13/04; G01N 17/00

(52) U.S. Cl. CPC G01N 15/0806; G01N 13/04; G01N 17/006

(57) ABSTRACT

A high-pressure flow-circulating hydrogen permeation test device and method, including: a base, and an autoclave body and a compressor being fixedly arranged on the base, wherein a side wall of the autoclave body is fixedly provided with a sample clamp, a first end of the sample clamp is clamped with a sample and extends into the interior of the autoclave body, a second end of the sample clamp is fixedly provided with a hydrogen permeation test device, an interior of the sample clamp is communicated with the hydrogen permeation test device, the hydrogen permeation test device contains an electrolyte in contact with the sample, and a gas inlet and a gas outlet of the autoclave body are both connected with the compressor through pipelines.

The present invention claims priority benefits to Chinese Patent Application number 202211606866.8, entitled “a high-pressure flow-circulating hydrogen permeation test device and method”, filed on Dec. 14, 2022, with the China National Intellectual Property Administration (CNIPA), the entire contents of which are incorporated herein by reference.

### TECHNICAL FIELD

The present invention relates to the technical field of hydrogen permeation tests, particularly to a high-pressure flow-circulating hydrogen permeation test device and method.

### BACKGROUND

Hydrogen energy is a clean and zero-carbon secondary energy source with high energy density, and has a huge development potential in a renewable new energy system in the future. Production of hydrogen by electrolysis of water utilizing renewable energy and by-production of hydrogen in petrochemical industry are main sources for hydrogen energy, and the transport of hydrogen mixed natural gas and the transport of pure hydrogen are typically completed through pipelines.

The inventor finds that the entry of an hydrogen element into a pipeline metal can affect the plasticity and toughness of a base and then accelerate the corrosion of the pipeline; hydrogen is adsorbed onto the surface of pipeline steel, which can reduce the mechanical properties of the pipeline; after the surface of the material is corroded, hydrogen permeation is easily generated, leading to hydrogen brittleness which in turn causes hydrogen induced cracking and corrosion fatigue. The study on the permeation and corrosion of hydrogen on a pipe in a flow state is essentially important to the transport of hydrogen mixed natural gas and the transport of pure hydrogen. However, the existing hydrogen permeation autoclave can only test the hydrogen permeation degree of hydrogen in a static state, but cannot truly simulate the hydrogen permeation in the process of dynamic hydrogen transport.

### SUMMARY

In view of the defects in the prior art, the objective of the present invention is to provide a high-pressure flow-circulating hydrogen permeation test device and method, by utilizing a compressor to alter the change in airflow inside an autoclave body, to simulate different hydrogen flow working conditions, solving the problem that the existing hydrogen permeation autoclave cannot simulate hydrogen permeation in the process of dynamic hydrogen transport.

In order to achieve the above objective, the present invention is achieved by the following technical solution:

In a first aspect, the present invention provides a high-pressure flow-circulating hydrogen permeation test device, comprising a base, and an autoclave body and a compressor which are fixedly arranged on the base, wherein the side wall of the autoclave body is fixedly provided with a sample clamp, a first end of the sample clamp is clamped with a sample and extends into the interior of the autoclave body, a second end of the sample clamp is fixedly provided with a hydrogen permeation test device, the interior of the sample clamp is communicated with the hydrogen permeation test device, the hydrogen permeation test device contains an electrolyte in contact with the sample, and a gas inlet and a gas outlet of the autoclave body are both connected with the compressor through pipelines.

As a further implementation mode, the side wall of the autoclave body is fixedly provided with a single window, the sample clamp is arranged in the single window, and the single window is in threaded connection with a first gland to achieve the fixation of the sample clamp.

As a further implementation mode, the sample clamp is in a hollow structure, the sample clamp consists of a clamping portion, a press socket, the first gland and a second gland which are connected in turn, the first gland is in threaded connection with the second gland and the single window respectively to compress the press socket, the clamping portion is arranged in the end portion of the base, a pressure cap is in threaded connection with the end portion of the base provided with the clamping portion to compress the clamping portion, and a sealing ring is arranged between the press socket and the single window.

As a further implementation mode, the clamping portion consists of a first clamping portion and a second clamping portion, a first end of the first clamping portion and a first end of the second clamping portion are both in a stepped structure, and the stepped first end of the second clamping portion is inserted into the interior of the stepped first end of the first clamping portion.

As a further implementation mode, the interiors of the first clamping portion and the second clamping portion are both provided with sealing rings, and the sample is located between the two sealing rings inside the first clamping portion and the second clamping portion.

As a further implementation mode, the interior of the clamping portion is hollow and the two ends of the clamping portion are both circular truncated cone-shaped grooves, and the pressure cap has a through hole communicated with the interior of the clamping portion and the end portions of the through hole are both in a flared structure.

As a further implementation mode, the press socket and the single window are both in a parallel cross-section structure, and sealing between the press socket and the single window is achieved by line sealing and sealing rings.

As a further implementation mode, the second gland is inserted into the interior of the first gland and extends out of the first gland to contact with the press socket.

As a further implementation mode, the hydrogen permeation test device is an electrolytic tank inside which a sodium hydroxide solution is contained as the electrolyte.

In a second aspect, the present invention provides a high-pressure flow-circulating hydrogen permeation test method, specifically comprising:
clamping a sample by using a sample clamp and allowing the sample clamp to be fixedly arranged in a single window, so that the sample is located inside an autoclave body and contacts with a gas inside the autoclave body; and exhausting residual gases in the device by using nitrogen with inflation and exhaust for several times, inflating an experimental gas into the autoclave body after a current is stable, turning on a compressor, adjusting the number of revolutions, and then conducting relevant experiment detections.

The present invention has the following beneficial effects:
(1) The sample is fed into the interior of the autoclave through the sample clamp, and power is provided through the compressor, so that hydrogen in the pipeline flows to simulate the flow of hydrogen in the pipeline and then test the hydrogen permeation degree of hydrogen on the material in a motion state, the simulated working condition is closer to an actual situation, and the simulation effect is more correct.
(2) When the compressor is not turned on, the device of the present invention can be used for simulating the hydrogen permeation degree of hydrogen on the material in the static state, and the device is strong in entire adaptive capability, and can simulate different working conditions according to actual situations.
(3) The interior of the clamping portion is provided with the through hole and the two ends of the through hole are both in a flared structure, the pressure cap has a channel communicated with the interior of the clamping portion and the end portion of the channel is in a flared structure, which facilitates the contact between hydrogen and the sample, and avoids incomplete contact while preventing bubbles existing between the electrolyte and the sample and avoiding the influence of the bubbles on test data.
(4) The sealing rings are arranged between the first clamping portion and the sample, between the second clamping portion and the sample and between the press socket and the single window, and sealing between the press socket and the single window is achieved through line sealing, effectively preventing the hydrogen inside the autoclave from escape, ensuring the pressure in the autoclave to be maintained as a certain value, and guaranteeing the safety of the experimental environment.

### BRIEF DESCRIPTION OF THE DRAWINGS

The drawings of the specification consisting of a part of the present invention are intended to provide further understanding of the present invention, the illustrative embodiments of the present invention and descriptions thereof are used for explaining the present invention, but not constituting the improper limitation of the present invention.

FIG. 1 is an axis-side diagram of a high-pressure flow-circulating hydrogen permeation test device according to one or more embodiments of the present invention;

FIG. 2 is a structural front view of a high-pressure flow-circulating hydrogen permeation test device according to one or more embodiments of the present invention;

FIG. 3 is a structural partial section view of a high-pressure flow-circulating hydrogen permeation test device according to one or more embodiments of the present invention;

FIG. 4 is a structural diagram of a sample clamp according to one or more embodiments of the present invention;

FIG. 5 is a cross-section structural diagram of a sample clamp according to one or more embodiments of the present invention.

In the figures, the spacing or size between each part is exaggerated to display their positions, and the schematic diagram is for illustrative purposes only.

Where, 1, autoclave body; 2, pressure cap; 3, first clamping portion; 4, second clamping portion; 5, press socket; 6, first gland; 7, second gland; 8, electrolytic tank; 9, sample; 10, single window; 11, compressor; 12, base; 13, upper pipe section; 14, lower pipe section.

### DETAILED DESCRIPTION

It is noted that the following detailed descriptions are illustrative and are intended to provide further explanation of the present invention. Unless stated otherwise, all technical and scientific terms used in this invention have the same meanings as those commonly understood by ordinary technicians in the technical field to which the present invention belongs.

As introduced by the background technology, the existing hydrogen permeation high-pressure autoclave can only test the hydrogen permeation degree of hydrogen in a static state, and cannot truly simulate the problem of hydrogen permeation in the dynamic transportation process of hydrogen. In order to solve the above technical problems, the present invention proposes a high-pressure flow-circulating hydrogen permeation test device and method.

### Example 1

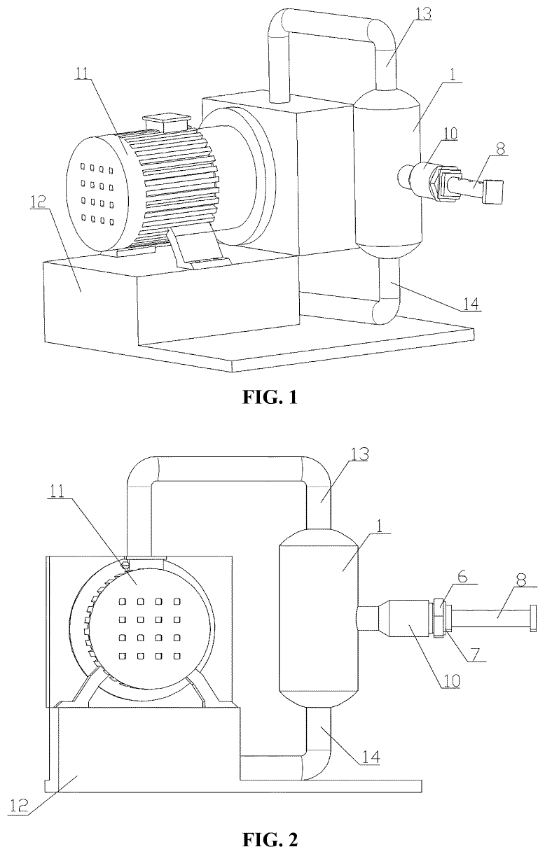

In a typical embodiment of the present invention, as shown in FIG. 1-FIG. 5, provided is a high-pressure flow-circulating hydrogen permeation test device, comprising an autoclave body 1, a sample clamp, a compressor 11 and a base 12.

The autoclave body 1 is an autoclave inside which hydrogen is filled; the sample clamp is used for clamping a sample 9 and extending into the interior of the autoclave body 1, so that the sample 9 contacts with hydrogen inside the autoclave body 1; the compressor 11 is mainly used for providing power to stir hydrogen inside the autoclave body 1 to simulate the flow of hydrogen in a pipeline.

The autoclave body 1 and the compressor 11 are both fixedly arranged on the base 12, the autoclave body 1 is connected with the compressor 11 through a circulation line, so as to stir hydrogen inside the autoclave body 1 through the compressor 11.

The autoclave body 1 has a single window 10, the lower end of the autoclave body 1 is a hydrogen inlet which is integrally welded with a lower pipe section 14, the upper end of the autoclave body 1 is a hydrogen outlet which is integrally welded with an upper pipe section 13, and the single window 10 is internally provided with internal threads for fixing a first gland 6 and then fixing the sample clamp.

The bottom of the compressor 11 is connected with the base 12, and the upper end of the compressor is provided with an inlet which is integrally welded with the upper pipe section 13; the lower end of the compressor is provided with an outlet which is integrally welded with the lower pipe section 14, so as to provide power for the flow of hydrogen.

In this example, power is provided for the flow of hydrogen through the compressor 11 to simulate the flow of hydrogen in the pipeline, thereby testing the hydrogen permeation degree of hydrogen on a material in a motion state. Compared with the exiting autoclave that only can simulate the static state of hydrogen, the simulation effect is more correct, which is closer to actual situations.

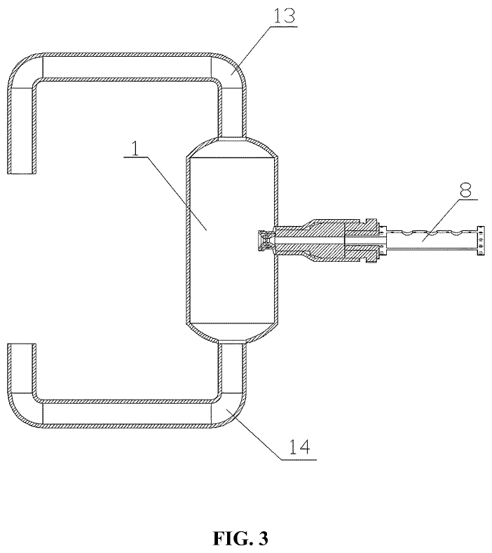

As shown in FIG. 3, the single window 10 is arranged on the side wall of the autoclave body 1, is fixedly connected with the autoclave body 1 into a whole through welding, and is in a hollow shell structure. The entire single window 10 is divided into three parts that are coaxially arranged, a first part and a third part are cylindrical, the first part is fixedly connected with the side wall of the autoclave body 1 and has a diameter smaller than the diameters of other two parts, the diameter of the third part is larger and is provided with internal threads, the third part is fixedly connected with the first part through the second part, and the second part is horn-shaped.

It can be understood that the first part, second part and third part of the single window 10 can be fixedly connected through welding, or can be integrally molded. Specific situations can be determined based on actual design requirements without excess limitations here.

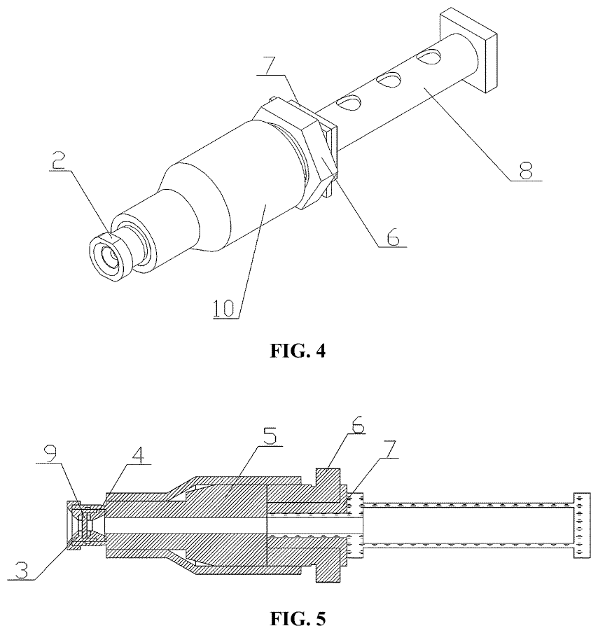

As shown in FIG. 4 and FIG. 5, the sample clamp consists of a pressure cap 2, a first clamping portion 3, a second clamping portion 4, a press socket 5, a first gland 6 and a second gland 7. After being assembled, the sample clamp is mounted in the single window 10 of the autoclave body 1 for clamping and fixing the sample 9.

The press socket 5 is in a hollow three-stepped structure. The first step and the second step are both cylindrical shells, the side wall of the inner side of the first step is provided with a trench for placing O-shaped sealing rings; the outer diameter of the second step is larger than that of the first step, the third step is in a parallel cross-section structure and specifically is an obliquely cut cylindrical shell, and the first step, second step and third step are coaxially arranged.

The first step of the press socket 5 is internally provided with the first clamping portion 3 and the second clamping portion 4 that are used for clamping the sample 9, a first end of the first clamping portion 3 and a first end of the second clamping portion 4 are both in a stepped structure, the stepped first end of the second clamping portion 4 is inserted into the interior of the stepped first end of the first clamping portion 3, a second end of the second clamping portion 4 contacts with the end portion of the second step of the press socket 5, the first clamping portion 3 and the second clamping portion 4 are fixed and compressed by utilizing the pressure cap 2 to clamp the sample 9 while ensuring the sealing.

Specifically, the first clamping portion 3 is in a cylindrical structure, the bottom (i.e., one side near the second clamping portion 4) of the first clamping portion 3 is internally cut to form a first cylindrical groove with a set depth, a first rectangular groove is dig in the first cylindrical groove and used for placing O-shaped sealing rings, the top of the first clamping portion 3 (i.e., one side far away from the second clamping portion 4) is internally cut to form a first circular truncated cone-shaped groove (a flared structure), and the bottom (i.e., a maximum diameter end) of the first circular truncated cone-shaped groove is placed on the top of the first clamping portion 3, and the first circular truncated cone-shaped groove and the first cylindrical groove are coaxially arranged and jointly constitute one through hole.

Similarly, the second clamping portion 4 is a cylinder whose outer diameter is the same as that of the first clamping portion 3, the bottom (one side far away from the first clamping portion 3) is internally cut to form a second circular truncated cone-shaped groove (a flared structure) with a set depth, and the bottom (i.e., a maximum diameter end) of the second circular truncated cone-shaped groove is located at the bottom of the second clamping portion 3, the top (i.e., one side near the first clamping portion 3) of the second clamping portion 4 is internally cut to form a second cylindrical groove with a set depth, and a second rectangular groove is dig in the second cylindrical groove and used for placing O-shaped sealing rings, and the outer wall of the top of the second clamping portion 4 is cut by a set depth for inserting the top of the second clamping portion 4 into the bottom of the first clamping portion 3 to jointly form a completed cylindrical structure.

The first step of the press socket 5 is provided with external threads, the pressure cap 2 is internally provided with internal threads matched with the first step, and the pressure cap 2 is fixedly connected with the press socket 5 through internal threads.

Specifically, the pressure cap 2 is in a cylindrical structure, the bottom of the pressure cap 2 is cut to form a third cylindrical groove with a set depth and provided with internal threads for connecting with the first step of the press socket 5, the top of the pressure cap is cut to form a third circular truncated cone-shaped groove with a set depth, and the bottom (i.e., a maximum diameter end) of the third circular truncated cone-shaped groove is located on the top of the pressure cap 2, and the third cylindrical groove and the third circular truncated cone-shaped groove jointly form one channel.

The first circular truncated cone-shaped groove on the top of the first clamping portion 3 and the third circular truncated cone-shaped groove (i.e., a flared structure) on the top of the pressure cap 2 are more beneficial for contact between hydrogen and the sample 9 relative to the cylindrical groove, avoiding incomplete contact; the second circular truncated cone-shaped groove at the bottom of the second clamping portion 4 is beneficial for contact between the sample 9 and an electrolyte, prevention of bubbles (bubbles can flow along the side wall of the second circular truncated cone-shaped groove) existing between the electrolyte and the sample 9, avoiding the influences of bubbles on test data.

It is noted that the first clamping portion 3 and the second clamping portion 4 are both in a non-metal structure to avoid the influences on test data.

The sample 9 is a round slice and is clamped between the first clamping portion 3 and the second clamping portion 4, and the sealing of high-pressure hydrogen is achieved through O-shaped sealing rings, the fixation of the sample 9 is achieved by rotating the pressure cap 2, and a clamping force between the first clamping portion 3 and the second clamping portion 4 is maintained through the pressure cap 2.

The first gland 6 is divided into two parts, one part is in a hexagonal prism structure, the other part is in a cylindrical structure and is equipped with internal and external threads, the external threads with the cylindrical structure are connected with the inner wall of the single window 10, the internal threads are connected with the outer wall of the second gland 7, a first end of the second gland 7 extends out of the first gland 6 and contacts with the press socket 5, the first gland 6 is entirely equipped with a round through hole for circulating the electrolyte, the matching between the press socket 5 and the single window 10 is maintained through matching between the first gland 6 and the inner wall of the third part of the single window 10.

The second gland 7 is used for assisting the first gland 6. When in threaded connection with the single window 10, the first gland 6 cannot continue to compress the press socket 5, and the press socket 5 is compressed through the second gland 7.

To prevent the leakage of a high-pressure gas inside the autoclave out from the single window 10, O-shaped sealing rings are used at three places, linear sealing is used at one place, the O-shaped sealing rings used at three places are respectively located between the first clamping portion 3 and the sample 9, between the second clamping portion 4 and the sample 9 and between the first step of the press socket 5 and the first part of the single window 10; linear sealing is located between the second step of the press socket 5 and the second part of the single window 10.

The sample clamp is in a hollow structure, a first end of the sample clamp is used for clamping the sample 9 and penetrating through the single window 10 to extend into the interior of the autoclave body 1, and a second end of the sample clamp is connected with a hydrogen permeation test device.

The hydrogen permeation test device is an electrolytic tank 8 which is equipped with two electrodes. The interior of the hydrogen permeation test device contains a sodium hydrogen solution as an electrolyte. The electrolytic tank 8 is a Devanathan-Stachurski dual-sided electrolytic tank. The sample 9 is sealed between a high-pressure reaction single window autoclave body 1 (a hydrogen inflating side) and the electrolytic tank 8 (a hydrogen testing side), an Hg/HgO electrode serves as a reference electrode, and a high-pure graphite electrode serves as an assisted electrode. When the quality of the sample 9 changes due to hydrogen permeation, the current will change, and then the hydrogen permeation of hydrogen can be monitored through the current change of the sample 9.

The entire autoclave body 1 is made of a Hastelloy alloy, which is a nickel-based corrosion-resistant alloy and has good corrosion resistance and thermal stability, ensuring the stability and safety of the autoclave body during the experiment.

For the autoclave, compressor 11 and a hydrogen permeation electrolytic tank device in this example, the compressor 11 is utilized to provide power for the flow of hydrogen to simulate the flow of hydrogen in the pipeline, the electrolytic tank 8 is utilized to perform real-time hydrogen permeation monitoring on the sample 9, and the rotation speed of the compressor 11 is adjusted to simulate the hydrogen permeation degrees of hydrogen in different flow rates.

### Example 2

In another typical embodiment of the present invention, provided is high-pressure flow-circulating hydrogen permeation test method, specifically comprising:
when the autoclave is assembled, three O-shaped sealing rings are placed in three rectangular grooves of a first clamping portion 3 and a second clamping portion 4 to fix the sample through the first clamping portion 3 and the second clamping portion 4; and
the first clamping portion 3 and the second clamping portion 4 are placed in a first-stepped hollow cylinder of a press socket 5, a pressure cap 2 and the press socket 5 are connected with a single window 10 through threads to clamp a sample 9; a first gland is connected with the single window 10 through threads; a second gland 7 is connected with the first gland 6 through threads; an electrolytic tank 8 is in interference fit connection with the second gland 7 so as to complete the installation;
when in use, nitrogen is used to exhaust residual gases in the device with inflation and exhaust for three times, an experimental gas (hydrogen) is inflated into an autoclave body 1, a compressor 11 is turned on, the number of revolutions is adjusted, relevant experimental detections are conducted, power is provided by the compressor 11 so that hydrogen in the pipeline flows to simulate the flow of hydrogen in the pipeline, and then the hydrogen permeation degree of hydrogen on a material in the motion state.

The above descriptions are preferred embodiments of the present invention, but not intended to limit the present invention. Various changes and variations can be made to the present invention by those skilled in the art. Any modifications, equivalent replacements, improvements and the like made with the spirit and principle of the present invention all should be included within the scope of protection of the present invention.

1. A high-pressure flow-circulating hydrogen permeation test device, comprising a base, and an autoclave body and a compressor being fixedly arranged on the base, wherein a side wall of the autoclave body is fixedly provided with a sample clamp, a first end of the sample clamp is clamped with a sample and extends into an interior of the autoclave body, a second end of the sample clamp is fixedly provided with a hydrogen permeation test device, an interior of the sample clamp is communicated with the hydrogen permeation test device, the hydrogen permeation test device contains an electrolyte in contact with the sample, and a gas inlet and a gas outlet of the autoclave body are both connected with the compressor through pipelines.

2. The high-pressure flow-circulating hydrogen permeation test device according to claim 1, wherein the side wall of the autoclave body is fixedly provided with a single window, the sample clamp is arranged in the single window and the single window is in threaded connection with a first gland to achieve a fixation of the sample clamp.

3. The high-pressure flow-circulating hydrogen permeation test device according to claim 2, wherein the sample clamp is in a hollow structure, comprising a clamping portion, a press socket, the first gland and a second gland being connected in turn, the first gland is in threaded connection with the second gland and the single window respectively to compress the press socket, the clamping portion is arranged in an end portion of the base, a pressure cap is in threaded connection with an end portion of the base provided with the clamping portion to compress the clamping portion, and a sealing ring is arranged between the press socket and the single window.

4. The high-pressure flow-circulating hydrogen permeation test device according to claim 3, wherein the clamping portion consists of a first clamping portion and a second clamping portion, a first end of the first clamping portion and a first end of the second clamping portion are both in a stepped structure, wherein the stepped first end of the second clamping portion is inserted into an interior of the stepped first end of the first clamping portion.

5. The high-pressure flow-circulating hydrogen permeation test device according to claim 4, wherein an interior of the first clamping portion and an interior of the second clamping portion are both provided with sealing rings, the sample is located between the two sealing rings inside the first clamping portion and the second clamping portion.

6. The high-pressure flow-circulating hydrogen permeation test device according to claim 4, wherein the interior of the clamping portion is provided with a through hole and a first end and a second end of the through hole are both in a flared structure, the pressure cap has a channel communicated with the interior of the clamping portion and an end portion of the channel is in a flared structure.

7. The high-pressure flow-circulating hydrogen permeation test device according to claim 3, wherein the press socket and the single window are both in a parallel cross-section structure, and sealing between the press socket and the single window is achieved by line sealing and sealing rings.

8. The high-pressure flow-circulating hydrogen permeation test device according to claim 3, wherein the second gland is inserted into an interior of the first gland and extends out of the first gland to contact with the press socket.

9. The high-pressure flow-circulating hydrogen permeation test device according to claim 1, wherein the hydrogen permeation test device is an electrolytic tank and a sodium hydroxide solution is contained therein as the electrolyte.

10. A high-pressure flow-circulating hydrogen permeation test method utilizing the high-pressure flow-circulating hydrogen permeation test device according to claim 1, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

11. A high-pressure flow-circulating hydrogen permeation test method utilizing the high-pressure flow-circulating hydrogen permeation test device according to claim 2, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

12. A high-pressure flow-circulating hydrogen permeation test method utilizing the high-pressure flow-circulating hydrogen permeation test device according to claim 3, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

13. A high-pressure flow-circulating hydrogen permeation test method utilizing the high-pressure flow-circulating hydrogen permeation test device according to claim 4, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

14. A high-pressure flow-circulating hydrogen permeation test method utilizing the high-pressure flow-circulating hydrogen permeation test device according to claim 5, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

15. A high-pressure flow-circulating hydrogen permeation test method utilizing the high-pressure flow-circulating hydrogen permeation test device according to claim 6, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

16. A high-pressure flow-circulating hydrogen permeation test method utilizing the high-pressure flow-circulating hydrogen permeation test device according to claim 7, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

17. A high-pressure flow-circulating hydrogen permeation test method utilizing the high-pressure flow-circulating hydrogen permeation test device according to claim 8, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.

18. A high-pressure flow-circulating hydrogen permeation test method utilizing the high-pressure flow-circulating hydrogen permeation test device according to claim 9, specifically comprising:
clamping a sample by using a sample clamp and allowing the sample clamp to be fixedly arranged in a single window, so that the sample is located inside an autoclave body and contacts with a gas inside the autoclave body; and
exhausting residual gases in the device by using nitrogen with inflation and exhaust for several times, inflating an experimental gas into the autoclave body after a current is stable, turning on a compressor, adjusting the number of revolutions, and then conducting relevant experiment detections.
